(19) United States
(12) Patent Application Publication
(10) Pub. No.: US 2025/0193764 A1
(43) Pub. Date: Jun. 12, 2025

(54) A CONDITIONAL RECONFIGURATION CORRESPONDING TO HANDOVER TO A TARGET CELL

(71) Applicant: Lenovo (Singapore) Pte. Ltd., New Tech Park (SG)

(72) Inventors: Hyejung Jung, Northbrook, IL (US); Sher Ali Cheema, Ilmenau (DE); Hyung-Nam Choi, Ottobrunn (DE); Joachim Löhr, Wiesbaden (DE); Vijay Nangia, Woodridge, IL (US); Majid Ghanbarinejad, Chicago, IL (US)

(21) Appl. No.: 18/844,815

(22) PCT Filed: Mar. 9, 2023
(86) PCT No.: PCT/IB2023/052266

§ 371 Date: Sep. 6, 2024

Related U.S. Application Data
(60) Provisional application No. 63/318,300, filed on Mar. 9, 2022.

(51) Int. Cl. H04W 36/36; H04W 24/10; H04W 48/08; H04W 74/0833

(52) U.S. Cl. CPC H04W 36/362; H04W 24/10; H04W 48/08; H04W 74/0833

(57) ABSTRACT

Apparatuses, methods, and systems are disclosed for a conditional reconfiguration corresponding to handover (“HO”) to a target cell. One method includes receiving, at a user equipment (“UE”), a conditional reconfiguration including at least one set of reconfiguration parameters. Each set of reconfiguration parameters of the at least one set of reconfiguration parameters corresponds to each candidate target cell of at least one candidate target cell. The method includes acquiring a system information block (“SIB”) type of a source cell. The SIB type is associated with a candidate target cell of the at least one candidate target cell. The method includes performing a HO to the candidate target cell in response to an execution condition associated with the candidate target cell being fulfilled and the SIB type being associated with the candidate target cell being acquired.

### FIELD

The subject matter disclosed herein relates generally to wireless communications and more particularly relates to a conditional reconfiguration corresponding to handover (“HO”) to a target cell.

### BACKGROUND

In certain wireless communications networks, there may be terrestrial (“TN”) and non-TN (“NTN”) networks. In such networks, there may be switching between the TN and NTN networks.

### BRIEF SUMMARY

Methods for a conditional reconfiguration corresponding to HO to a target cell are disclosed. Apparatuses and systems also perform the functions of the methods. One embodiment of a method includes receiving, at a user equipment (“UE”), a conditional reconfiguration including at least one set of reconfiguration parameters. Each set of reconfiguration parameters of the at least one set of reconfiguration parameters corresponds to each candidate target cell of at least one candidate target cell. In some embodiments, the method includes acquiring a system information block (“SIB”) type of a source cell. The SIB type is associated with a candidate target cell of the at least one candidate target cell. In certain embodiments, the method includes performing a HO to the candidate target cell in response to an execution condition associated with the candidate target cell being fulfilled and the SIB type being associated with the candidate target cell being acquired.

One apparatus for a conditional reconfiguration corresponding to HO to a target cell includes a UE. In some embodiments, the apparatus includes a receiver that receives a conditional reconfiguration including at least one set of reconfiguration parameters. Each set of reconfiguration parameters of the at least one set of reconfiguration parameters corresponds to each candidate target cell of at least one candidate target cell. In various embodiments, the apparatus includes a processor that: acquires a SIB type of a source cell, wherein the SIB type is associated with a candidate target cell of the at least one candidate target cell; and performs a HO to the candidate target cell in response to an execution condition associated with the candidate target cell being fulfilled and the SIB type being associated with the candidate target cell being acquired.

Another embodiment of a method for a conditional reconfiguration corresponding to HO to a target cell includes transmitting, from a network device to a UE connected to a cell, a conditional reconfiguration including at least one set of reconfiguration parameters. Each set of reconfiguration parameters of the at least one set of reconfiguration parameters corresponds to each candidate target cell of at least one candidate target cell of the UE. In some embodiments, the method includes transmitting a SIB type of the cell. The SIB type is associated with a candidate target cell of the at least one candidate target cell of the UE. A HO of the UE to the candidate target cell is performed in response to an execution condition associated with the candidate target cell being fulfilled and the SIB type being associated with the candidate target cell being acquired by the UE.

Another apparatus for a conditional reconfiguration corresponding to HO to a target cell includes a network device. In some embodiments, the apparatus includes a transmitter that:

transmits, to a UE connected to a cell, a conditional reconfiguration including at least one set of reconfiguration parameters, wherein each set of reconfiguration parameters of the at least one set of reconfiguration parameters corresponds to each candidate target cell of at least one candidate target cell of the UE; and transmits a SIB type of the cell. The SIB type is associated with a candidate target cell of the at least one candidate target cell of the UE. A HO of the UE to the candidate target cell is performed in response to an execution condition associated with the candidate target cell being fulfilled and the SIB type being associated with the candidate target cell being acquired by the UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for a conditional reconfiguration corresponding to HO to a target cell;

FIG. 2 is a schematic block diagram illustrating one embodiment of an apparatus that may be used for a conditional reconfiguration corresponding to HO to a target cell;

FIG. 3 is a schematic block diagram illustrating one embodiment of an apparatus that may be used for a conditional reconfiguration corresponding to HO to a target cell;

FIG. 4 is a schematic block diagram illustrating one embodiment of a system for a deployment scenario with two NTN-based next generation (“NG”)-radio access networks (“RANs”);

FIG. 5 is a schematic block diagram illustrating one embodiment of a system for a deployment scenario with TN-based and NTN-based NG-RANs;

FIG. 6 is a diagram illustrating one embodiment of a SIB Type X (“SIBx”) information element (“IE”);

FIGS. 7A-7D are diagrams illustrating one embodiment of a MeasNTNConfigSIB IE;

FIG. 8 is a diagram illustrating one embodiment of a SIB Type Y (“SIBy”)IE;

FIG. 9 is a schematic block diagram illustrating one embodiment of a system for a broadcast based HO procedure;

FIG. 10 is a schematic block diagram illustrating one embodiment of a system for a conditional HO procedure;

FIG. 11 is a flow chart diagram illustrating one embodiment of a method for a conditional reconfiguration corresponding to HO to a target cell; and

FIG. 12 is a flow chart diagram illustrating another embodiment of a method for a conditional reconfiguration corresponding to HO to a target cell.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

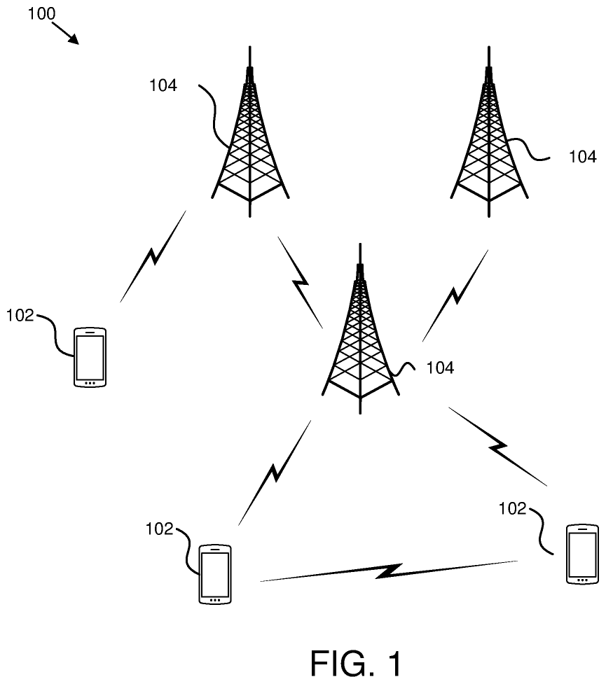

FIG. 1 depicts an embodiment of a wireless communication system 100 for a conditional reconfiguration corresponding to HO to a target cell. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-third generation partnership project (“3GPP”) gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an orthogonal frequency division multiplexing (“OFDM”) modulation scheme on the downlink (“DL”) and the remote units 102 transmit on the uplink (“UL”) using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive, at a UE, a conditional reconfiguration including at least one set of reconfiguration parameters. Each set of reconfiguration parameters of the at least one set of reconfiguration parameters corresponds to each candidate target cell of at least one candidate target cell. In some embodiments, the remote unit 102 may acquire a SIB type of a source cell. The SIB type is associated with a candidate target cell of the at least one candidate target cell. In certain embodiments, the remote unit 102 may perform a HO to the candidate target cell in response to an execution condition associated with the candidate target cell being fulfilled and the SIB type being associated with the candidate target cell being acquired. Accordingly, the remote unit 102 may be used for a conditional reconfiguration corresponding to HO to a target cell.

In certain embodiments, a network unit 104 may transmit, from a network device to a UE connected to a cell, a conditional reconfiguration including at least one set of reconfiguration parameters. Each set of reconfiguration parameters of the at least one set of reconfiguration parameters corresponds to each candidate target cell of at least one candidate target cell of the UE. In some embodiments, the network unit 104 may transmit a SIB type of the cell. The SIB type is associated with a candidate target cell of the at least one candidate target cell of the UE. A HO of the UE to the candidate target cell is performed in response to an execution condition associated with the candidate target cell being fulfilled and the SIB type being associated with the candidate target cell being acquired by the UE. Accordingly, the network unit 104 may be used for a conditional reconfiguration corresponding to HO to a target cell.

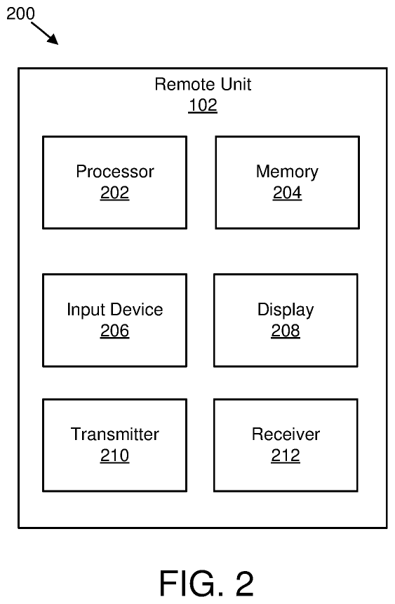

FIG. 2 depicts one embodiment of an apparatus 200 that may be used for a conditional reconfiguration corresponding to HO to a target cell. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 receives a conditional reconfiguration including at least one set of reconfiguration parameters. Each set of reconfiguration parameters of the at least one set of reconfiguration parameters corresponds to each candidate target cell of at least one candidate target cell. In various embodiments, the processor 202: acquires a SIB type of a source cell, wherein the SIB type is associated with a candidate target cell of the at least one candidate target cell; and performs a HO to the candidate target cell in response to an execution condition associated with the candidate target cell being fulfilled and the SIB type being associated with the candidate target cell being acquired.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

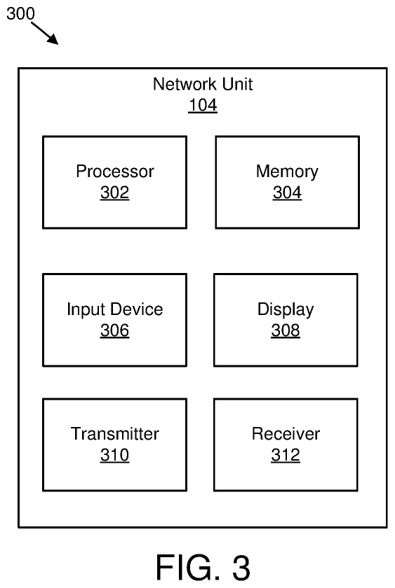

FIG. 3 depicts one embodiment of an apparatus 300 that may be used for a conditional reconfiguration corresponding to HO to a target cell. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310: transmits, to a UE connected to a cell, a conditional reconfiguration including at least one set of reconfiguration parameters, wherein each set of reconfiguration parameters of the at least one set of reconfiguration parameters corresponds to each candidate target cell of at least one candidate target cell of the UE; and transmits a SIB type of the cell. The SIB type is associated with a candidate target cell of the at least one candidate target cell of the UE. A HO of the UE to the candidate target cell is performed in response to an execution condition associated with the candidate target cell being fulfilled and the SIB type being associated with the candidate target cell being acquired by the UE.

It should be noted that one or more embodiments described herein may be combined into a single embodiment.

In certain embodiments, such as in rural areas, a TN based radio access may provide a limited data rate and limited reliability at a cell edge. In such embodiments, overlaying a NTN based NGRAN may be beneficial to achieve target service performances in terms of data rate and/or reliability. In underserved areas, multiple NTN-based NG-RANs with different satellite altitudes and orbits can provide partially or fully overlapped coverages.

In various embodiments, seamlessly switching between TN and NTN accesses and between one NTN and another NTN may be important to support service continuity and guarantee quality of service (“QoS”) requirements, especially for a relay UE in an on-board airplane, a high-speed train, or a high-speed vehicle.

In certain embodiments, there may be methods for NTN-TN and NTN-NTN measurement, mobility, and service continuity enhancements considering NTN characteristics such as satellite movement and different cell footprints dependent on different satellite altitudes.

In some embodiments, such as in one deployment scenario, a UE is connected to a 5th generation core network (“5GCN”) via a transparent NTN-based NG-RAN and may switch to a TN NG-RAN, or vice versa. In such embodiments, it is assumed that an NTN gateway is located in a public land mobile network (“PLMN”) area of a TN access network and that there is an Xn interface between a gNB of the NTN-based NG-RAN and a gNB of the TN NG-RAN.

In various embodiments, such as in another deployment scenario, a UE is connected to a 5GCN via a transparent NTN-based NG-RAN using geostationary earth orbit (“GEO”) satellites and may switch to another transparent NTN-based NG-RAN using low earth orbit (“LEO”) satellites, or vice versa. This deployment may be applicable to provide service to UEs in unserved areas. The LEO NTN-based NG-RAN featuring relatively low latency may be suitable to support a delay of sensitive traffics while the GEO NTN-based NG-RAN may be used for serving high-mobility UEs.

In certain embodiments, such as in yet another deployment scenario, a UE is connected to a 5GCN via a regenerative NTN-based NG-RAN with gNB on board using GEO satellites and may switch to another regenerative NTN-based NG-RAN with gNB on board using LEO satellites, or vice versa. An Xn interface between on-board gNBs can be realized using inter satellite links.

In some embodiments, such as in other deployment scenarios, a UE is connected to a 5GCN via a regenerative NTN-based NG-RAN with a gNB-distributed unit (“DU”) on board and a gNB-central unit (“CU”) on the ground and may switch to a TN NG-RAN, or vice versa. It is assumed that there is an Xn interface between the gNB-CU of the NTN-based NG-RAN and a gNB of the TN NG-RAN. An F1 interface in the NTN-based NG-RAN may need to adapt to a much longer roundtrip time of satellite radio interface (“SRI”).

It should be noted that there may be quite different delays in different NG-RANs facilitated by different types of satellites or other NTN platforms, either in radio access links (e.g., NR-Uu interface) or in backhaul and/or fronthaul links (e.g., Xn and F1 interfaces), or a combination of both.

In various embodiments, such as in new radio (“NR”), an RRC-connected UE can receive a conditional HO (“CHO”) command for robust HO. One drawback of CHO is that one or more candidate target cells may have to reserve radio resources including one or more physical random access channel (“PRACH”) resources (e.g., PRACH preambles and random access channel (“RACH”) occasions) for each UE until HO is triggered by a UE. If a significant percentage of UEs in a source cell are configured with CHO to a particular target cell, it may be difficult to efficiently use PRACH resources and may increase PRACH collisions for idle and inactive UEs in the target cell. Further, a radio resource control (“RRC”) signaling overhead for HO commands may be expected to be high with individual delivery of HO commands to a large number of UEs.

In certain embodiments, such as in NR NTN, a UE may perform conditional HO based on broadcasted timing information on when a cell is going to stop serving an area and a timer duration indicating a time duration [t1, t2] or based on location information.

In some embodiments, enhancements may be applicable to geosynchronous orbit (“GSO”) and non-GSO (“NGSO”), for example, LEO, medium earth orbit (“MEO”), highly elliptical orbit (“HEO”), based satellite access, high altitude platform station (“HAPS”) and air to ground (“ATG”) scenarios, and fixed and mobile very-small-aperture terminal (“VSAT”), e.g., airborne and maritime.

In various embodiments, NTN and TN may either operate in two different frequency bands (e.g., one band in frequency range 1 (“FR1”) corresponding to 410 MHz-7125 MHz and another band in frequency range 2 (“FR2”) corresponding to 24250 MHz-52600 MHz), or in a same frequency band (e.g., a band in FR1 or FR2). Frequency division duplex (“FDD”) mode is assumed for satellite operation above 10 GHz, while time division duplex (“TDD”) mode is assumed for TN operation in FR2.

In one example, a UE (e.g., outdoor handheld UEs) has TN and NTN connectivity capabilities and has omni-directional antenna type applicable to both TN and NTN connectivity. The NTN access may operate in frequency bands below or above 6 GHz. In another example, a relay UE on vehicles, ships, high speed trains, or airplanes is assumed to have TN and NTN connectivity capabilities and provides service to TN-only capable UEs outdoor or inside buildings, vehicles or trains and/or airplanes, respectively. The relay UE may have different antenna types for TN and NTN connectivity. The NTN access may operate in frequency bands below or above 6 GHz.

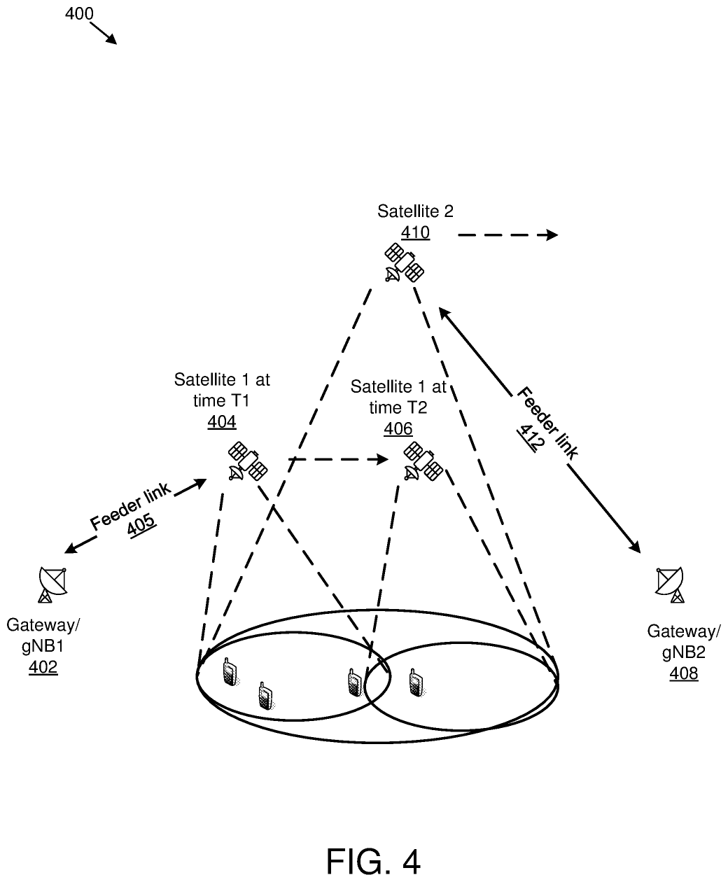

FIG. 4 is a schematic block diagram illustrating one embodiment of a system 400 for a deployment scenario with two NTN-based NG-RANs. The system 400 includes a first gateway (gNB1) 402, a satellite 1 at time T1 404 (e.g., there is a feeder link 405 between the first gateway 402 and the satellite 1 at time T1 404), a satellite 1 at time T2 405, a second gateway (gNB2) 408, and a satellite 2 410. Moreover, there is a feeder link 412 between the second gateway 408 and the satellite 2 410. The satellite 1 at time T1 404, the satellite 1 at time T2 406, and the satellite 2 410 all communicate with various UEs.

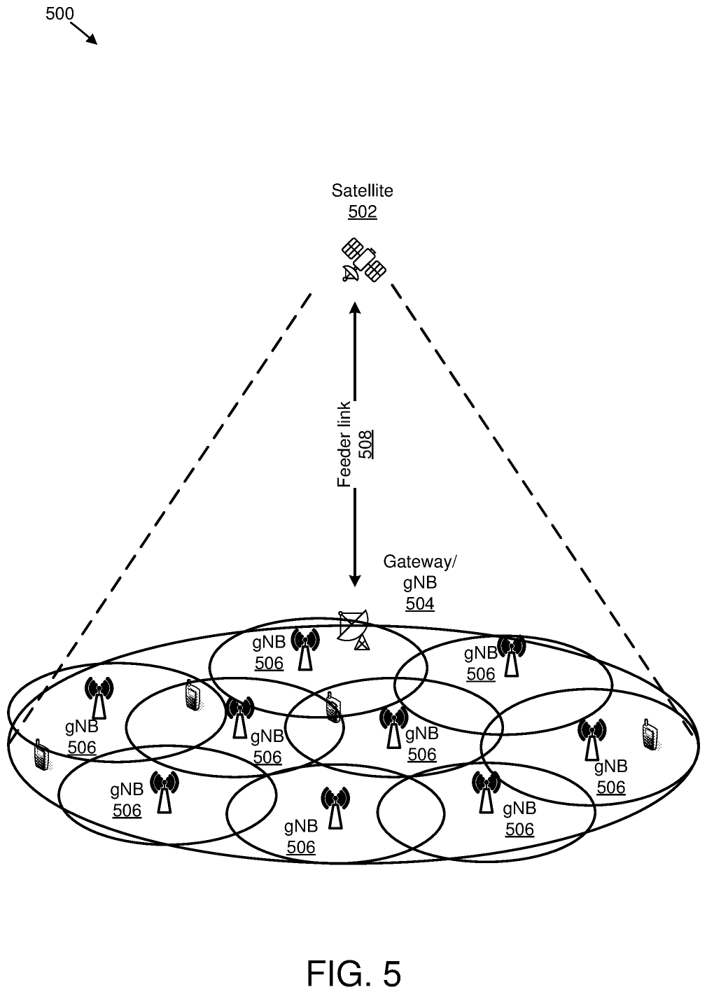

FIG. 5 is a schematic block diagram illustrating one embodiment of a system 500 for a deployment scenario with TN-based and NTN-based NG-RANs. The system 500 includes a satellite 502 that communicates with a gateway (gNB) 504, and multiple gNBs 506. The satellite 502 communicates with the gateway 504 via a feeder link 508.

In a first embodiment, there may be a broadcast based measurement and report configuration. In one embodiment, a cell provides a SIBx that includes measurement configuration information for all connected mode UEs served by the cell to measure one or more neighbor cells that have coverage overlapping with cell's coverage. Additionally, the SIBx may include measurement report configuration information for the one or more neighbor cells to be measured. In an implementation, the cell has coverage fully or significantly overlapping with those of the one or more neighbor cells included in the SIBx measurement configuration. In an example, the cell is a TN cell or an NTN cell provided by a LEO satellite, and the one or more neighbor cells are NTN cells provided by GEO satellites.

In the example shown in FIG. 4, satellite 1 is moving with an Earth moving beam footprint. Accordingly, UEs in a first cell provided by the satellite 1 at time T1 404 are expected to observe gradual cell quality degradation with satellite 1 moving away and may need to HO to a second cell provided by satellite 2 410 that provides a wider coverage. Since all UEs served by the first cell are likely to be handed over to the second cell eventually (e.g., when the first cell does not exist any more due to satellite 1's movement, or when the cell has moved to a different location along satellite 1's movement), a measurement configuration for the second cell can be common to all UEs served by the first cell and can be broadcast as a SIBx by the first cell.

In the example shown in FIG. 5, UEs served by an overlaying NTN cell may be configured with a cell-specific measurement and reporting configuration via a broadcast system information message of the NTN cell. The cell-specific measurement and reporting configuration comprises an indication of a set of cells (e.g., TN cells) that have coverages overlapping with a coverage of the NTN cell. In an implementation, a serving cell transmits a first number of synchronization signal (“SS”) and/or physical broadcast channel (“PBCH”) (“SS/PBCH”) blocks (“SSBs”) in an SSB burst set and performs beam sweeping of a system information message with a second number of physical downlink shared channels (“PDSCHs”), where each PDSCH is quasi-co-located with one SSB of the SSB burst set and includes the system information message including a SIBx that carries a cell-specific measurement and reporting configuration for RRC_CONNECTED UEs and where the second number is smaller than the first number. The serving cell provides an indication of a set of transmitted SSBs in the SSB burst set and further provides an indication of a subset of SSBs selected from the set of transmitted SSBs in the SSB burst set for beam sweeping of the SIBx, where each of the second number of PDSCHs carrying the system information messages is quasi-co-located (“QCL”) with each SSB of the subset of SSBs. That is, the serving cell (e.g., NTN cell) may broadcast the SIBx carrying a cell-specific measurement and reporting configuration with a subset of beams selected from a set of SSB transmission beams of the NTN cell. In another embodiment, a set of cells provide a SIBx in a single frequency network (“SFN”) manner (e.g., SIBx is transmitted by the set of cells on a common time and frequency resource), where the SIBx includes measurement configuration information of one or more overlaying cells that have coverages including coverages of the set of cells. UEs located in boundaries of two or more cells of the set of cells can receive the SIBx and can detect and measure the one or more overlaying cells based on assistant information in the SIBx. In an implementation, the set of cells transmitting the SIBx in the SFN manner coordinate to determine the common time and frequency resource for the SIBx delivery.

In certain embodiments, coordination between cells may include signaling among base stations (gNBs) providing the cells (e.g., on an Xn interface). In one example, one gNB is determined (e.g., according to a core network configuration from an access and mobility management function (“AMF”)). The gNB then selects the time and frequency resources for the SIBx delivery. In another example, selecting which cell makes the final decision on the resources is assisted by the NTN RAN or core network functionalities as knowledge of the NTN movement trajectory may impact the decision of which cells coordinate on the SFN configuration.

In the example shown in FIG. 5, a set of cells transmitting a SIBx are TN cells, and an overlaying cell is an NTN cell. In another example, the set of cells are NTN cells via LEO satellites, and the overlaying cell is an NTN cell via a GEO satellite.

In yet another embodiment, a cell configures a group of UEs served by the cell with a group-specific measurement and reporting configuration. For example, in FIG. 5, a group of UEs served by an overlaying NTN cell may be configured with a group-specific measurement and reporting configuration via group common physical downlink control channel (“PDCCH”) and PDSCH. The group-specific measurement and reporting configuration includes an indication of a subset of cells (e.g., TN cells) selected from a set of cells that have coverages overlapping with a coverage of the NTN cell.

In an example, SIBx contains cell-specific neighboring cell measurement and reporting information in RRC_CONNECTED.

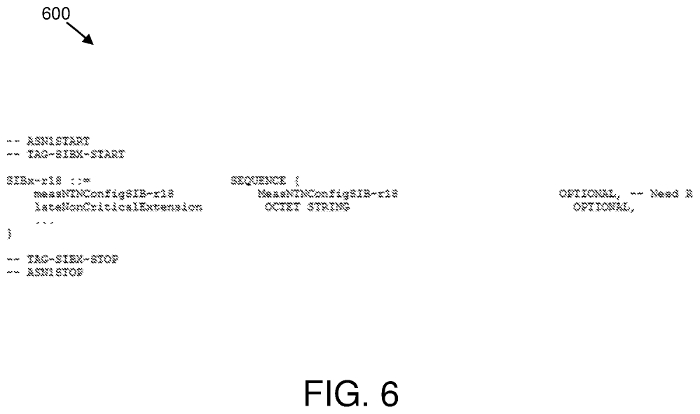

FIG. 6 is a diagram illustrating one embodiment of a SIBx IE 600.

In an example, there may be a MeasNTNConfigSIB IE. The MeasNTNConfigSIB IE is used to convey information to the UE about measurements and reporting requested to be done for NTN neighboring cells while in RRC_CONNECTED and optionally measurement requested to be done in RRC_IDLE and RRC_INACTIVE. Criteria for triggering of an NR measurement reporting event or of a HO or of a CHO or conditional primary secondary cell group (“SCG”) cell (“PSCell”) change (“CPC”) or dual active protocol stack (“DAPS”) event are included. For events labelled AN with N equal to 1, 2 and so on, measurement reporting events and CHO or CPC events are based on cell measurement results, which is derived based on SS/PBCH block. Such events may include: 1) Event A1: serving becomes better than absolute threshold; 2) Event A2: serving becomes worse than absolute threshold; 3) Event A3: neighbor becomes amount of offset better than primary cell (“PCell”) and/or PSCell; 4) Event A4: neighbor becomes better than absolute threshold; 5) Event A5: PCell and/or PSCell becomes worse than absolute threshold 1 AND neighbor and/or secondary cell (“SCell”) becomes better than another absolute threshold 2; 6) Event A6: neighbor becomes amount of offset better than SCell; 7) CondEvent A3: conditional reconfiguration candidate becomes amount of offset better than PCell and/or PSCell; and/or 8) CondEvent A5: PCell and/or PSCell becomes worse than absolute threshold 1 AND conditional reconfiguration candidate becomes better than another absolute threshold 2.

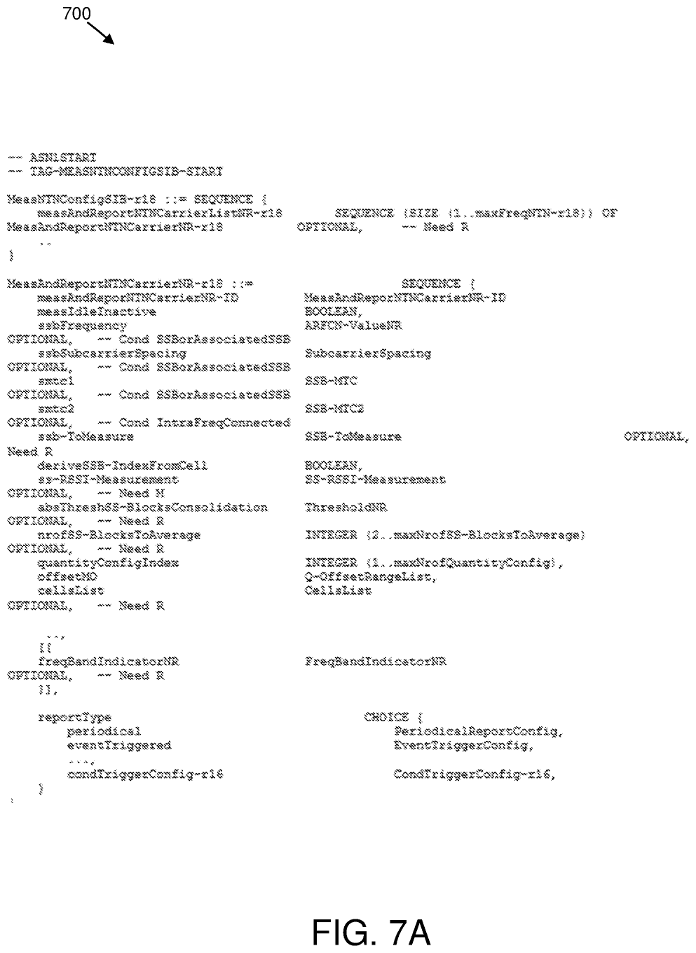

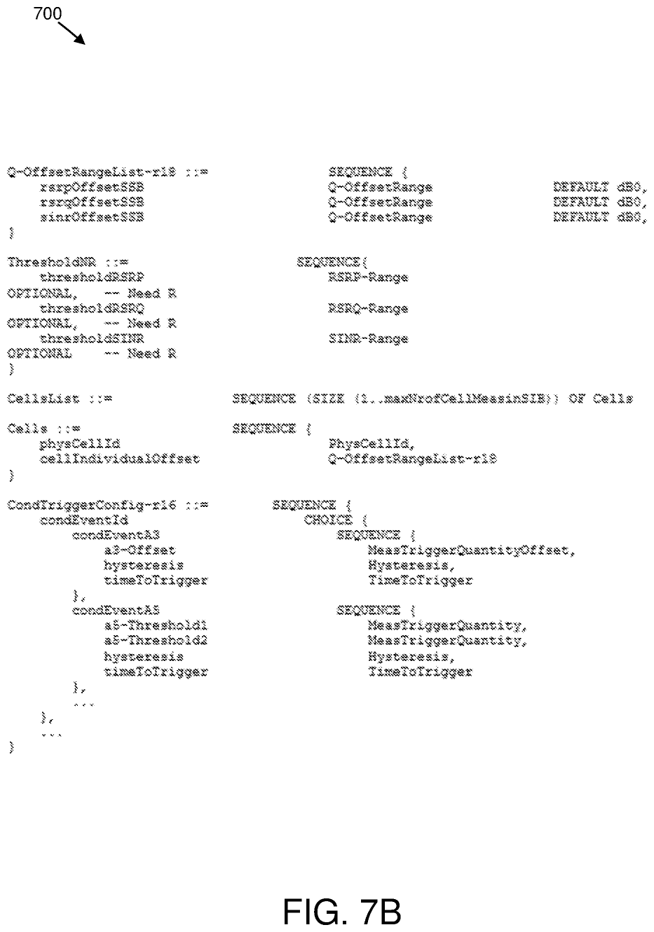

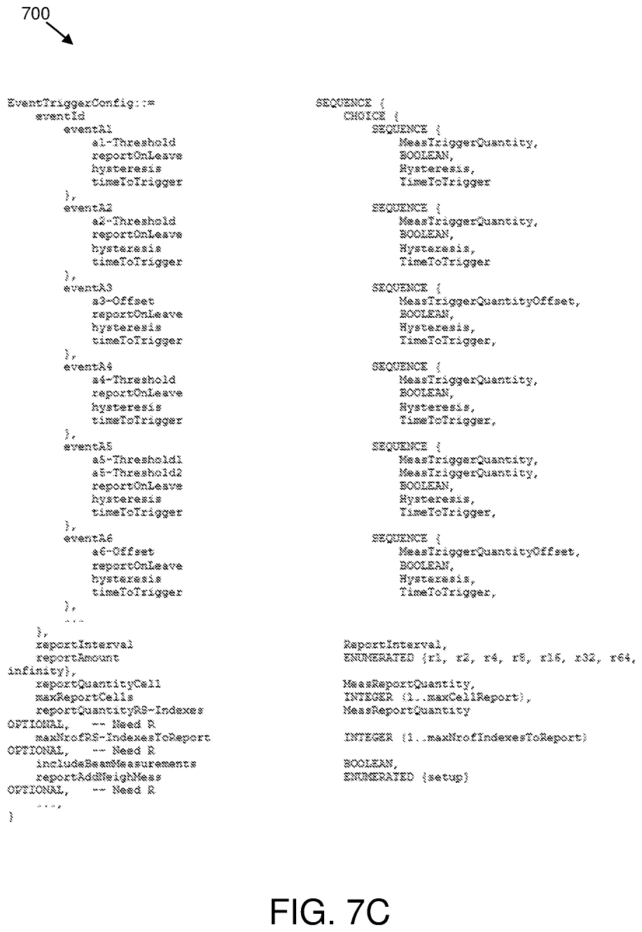

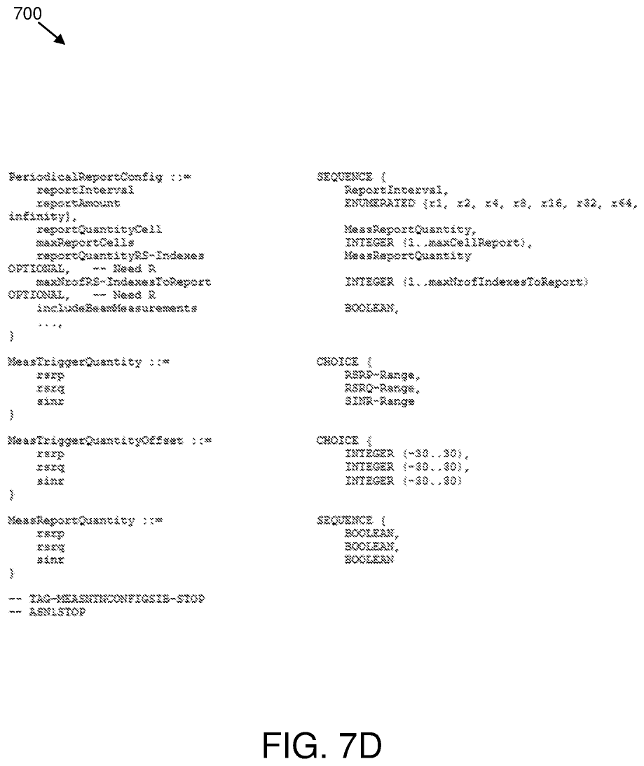

FIGS. 7A through 7D are diagrams illustrating one embodiment of a MeasNTNConfigSIB IE 700.

In certain embodiments, there may be a measIdleInactive field. If this field is set to true, a measurement configuration is to be stored and used by UEs in RRC_IDLE or RRC_INACTIVE. In some embodiments, there may be a measAndReporNTNCarrierNR-ID field. There may be a measurement and report configuration identity for an NR carrier with configuration information as found in Table 1. Further, Table 2 may indicate EventTriggerConfig field descriptions.

TABLE 1
smtc1
Primary measurement timing configuration.
smtc2
Secondary measurement timing configuration for SS corresponding to physical cell identity
(PCI) listed in CellsList. For these SS, the periodicity is indicated by periodicity in smtc2 and
the timing offset is equal to the offset indicated in periodicityAndOffset modulo periodicity.
periodicity in smtc2 can only be set to a value strictly shorter than the periodicity indicated by
periodicityAndOffset in smtc1 (e.g. if periodicityAndOffset indicates sf10, periodicity can only
be set of sf5, if periodicityAndOffset indicates sf5, smtc2 cannot be configured).
ssbFrequency
Indicates the frequency of the SS associated with this MeasAndReportNTNCarrierNR.
Frequencies are considered to be on the sync raster if they are also identifiable with a global
synchronization channel number (GSCN) value.
ssbSubcarrierSpacing
Subcarrier spacing of SSB. Only the values 15 kHz or 30 kHz (FR1), and 120 kHz or 240 kHz
(FR2) are applicable.

TABLE 2
a3-Offset/a6-Offset
Offset value(s) to be used in NR measurement report triggering condition for event a3/a6. The
actual value is field value * 0.5 dB.
aN-ThresholdM
Threshold value associated to the selected trigger quantity (e.g., reference signal received
power (“RSRP”), references signal received quality (“RSRQ”), signal-to-interference and
noise ratio (“SINR”)) per RS Type (e.g. SS/PBCH block, channel state information (“CSI”)
reference signal (“RS”) (“CSI-RS”)) to be used in NR measurement report triggering condition
for event number aN. If multiple thresholds are defined for event number aN, the thresholds
are differentiated by M. The network configures aN-Threshold1 only for events A1, A2, A4,
A5 and a5-Threshold2 only for event A5. In the same eventA5, the network configures the
same quantity for the MeasTriggerQuantity of the a5-Threshold1 and for the
MeasTriggerQuantity of the a5-Threshold2.
channelOccupancyThreshold
RSSI threshold which is used for channel occupancy evaluation.
eventId
Choice of NR event triggered reporting criteria.
maxNrofRS-IndexesToReport
Max number of RS indexes to include in the measurement report for A1-A6 events.
maxReportCells
Max number of non-serving cells to include in the measurement report.
reportAddNeighMeas
Indicates that the UE shall include the best neighbour cells per serving frequency.
reportAmount
Number of measurement reports applicable for eventTriggered as well as for periodical report
types.
reportOnLeave
Indicates whether or not the UE shall initiate the measurement reporting procedure when the
leaving condition is met for a cell in cellsTriggeredList.
reportQuantityCell
The cell measurement quantities to be included in the measurement report.
reportQuantityRS-Indexes
Indicates which measurement information per RS index the UE shall include in the
measurement report.
timeToTrigger
Time during which specific criteria for the event needs to be met in order to trigger a
measurement report.

In one implementation, a UE applies a UE-specific time offset with respect to a configured SSB measurement time configuration (“SMTC”) to compensate propagation delay.

In a second embodiment, there may be broadcast based target cell system information delivery and conditional HO activation. In one embodiment, a first cell broadcasts cell-specific system information of a second cell (e.g., in SIBy in response to receiving on-demand system information request from a UE served by the first cell. The first and second cells may have overlapped coverage (e.g., the second cell overlays and/or overlaps with the first cell).

In an implementation, a UE receives a configuration that indicates association between a potential target cell and a SIB type of a serving cell, the SIB type including cell-specific parameters of the potential target cell, and a configuration for on-demand SI request (e.g., DedicatedSIBRequest-r18 or RRCSystemInfoRequest-r18). Further, the UE receives a measurement and reporting configuration including at least one system information (“SI”) request triggering condition and transmits a request for on-demand SI upon the corresponding SI request triggering condition being met. For example, triggering conditions include: 1) a candidate cell associated with an on-demand SI becomes an amount of offset better than PCell and/or PSCell; or 2) PCell and/or PSCell becomes worse than absolute threshold 1 AND a candidate cell associated with an on-demand SI becomes better than another absolute threshold 2.

In another implementation, a predefined SIB type (e.g., SIBy) includes an indication of a target cell and cell-specific parameters of the target cell.

For example, a measurement and reporting configuration includes one or more sets of conditions, each set of conditions triggering for a UE to send a request for on-demand SI of a particular target cell to a serving cell, where the requested on-demand SI includes cell specific parameters servingCellConfigCommon of the particular target cell. In one example, the request for on-demand SI of the particular target cell is sent via an RRC message of dedicated control channel (“DCCH”) in signaling radio bearer 1 (“SRB1”), e.g., DedicatedSIBRequest-r18 message, including an indication of the particular target cell. In another example, the request for on-demand SI of the particular target cell is sent via an RRC message of common control channel (“CCCH”) in signaling radio bearer 0 (“SRB0”), e.g., RRCSystemInfoRequest-r18 message, including an indication of the particular target cell. In other examples, the request for on-demand SI of the particular target cell is sent via a corresponding PRACH preamble and/or PRACH resource (e.g., RACH occasions) of the serving cell that are associated with the SI request for the particular target cell. The indication of the particular target cell can be an explicit indication, e.g., a cell identity, and/or an implicit indication, e.g., an indication of a particular SIB type corresponding to the particular target cell based on mapping between a target cell and a SIB type.

In one example implementation, the UE may operate according to Table 3.

TABLE 3

| 1> | if SIB1 includes si-SchedulingInfo containing si-RequestConfigSUL and criteria | |
|---|---|---|
| | to select supplementary uplink is met: | |
| | 2> | trigger the lower layer to initiate the Random Access procedure on |
| | | supplementary uplink using the PRACH preamble(s) and PRACH resource(s) |
| | | (i.e. RACH occasion(s)) in si-RequestConfigSUL corresponding to the SI |
| | | message(s) that the UE requires to perform a serving cell change (i.e. HO) to a |
| | | target cell; |
| | 2> | if acknowledgement for SI request is received from lower layers: |

| | |
|---|---|
| 3> | acquire the requested SI message(s), immediately; |

| 1> | else if SIB1 includes si-SchedulingInfo containing si-RequestConfig and criteria | |
|---|---|---|
| | to select normal uplink is met: | |
| | 2> | trigger the lower layer to initiate the random access procedure on normal |
| | | uplink using the PRACH preamble(s) and PRACH resource(s) in si- |
| | | RequestConfig corresponding to the SI message(s) that the UE requires to |
| | | perform a serving cell change (i.e. HO) to a target cell; |
| | 2> | if acknowledgement for SI request is received from lower layers: |

| | |
|---|---|
| 3> | acquire the requested SI message(s), immediately; |

| 1> | else: | |
|---|---|---|
| | 2> | set the contents of RRCSystemInfoRequest-r18 message as follows: |

| | |
|---|---|
| 3> | set the requested-SI-List to indicate the SI message(s) that the UE requires |
| | to perform a serving cell change (i.e. HO) to a target cell; |

| | |
|---|---|
| 2> | submit the RRCSystemInfoRequest message to lower layers for transmission; |
| 2> | if acknowledgement for RRCSystemInfoRequest message is received from |
| | lower layers: |

| | |
|---|---|
| 3> | acquire the requested SI message(s), immediately. |

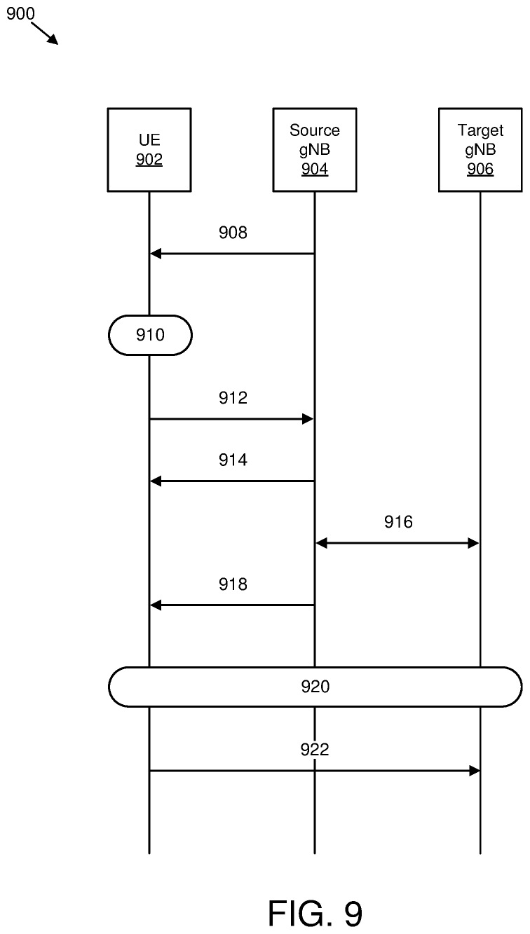

In some embodiments, while or after a UE acquires a necessary SIB corresponding to a target cell, the UE may also receive a HO command, as shown in FIG. 9 (e.g., RRC reconfiguration message with parameter ReconfigurationWithSync-r18, which includes a new radio network temporary identifier (“RNTI”) value and a dedicated random access channel (“RACH”) resource for uplink synchronization with the target cell but excludes cell-specific configuration parameter spCellConfigCommon).

According to one implementation, a UE upon having received a HO command excluding cell-specific configuration parameter needs to acquire the necessary SIB corresponding to the target cell, e.g., target cell as indicated in the HO command, before executing the HO command. In one example, the UE aggregates the cell-specific information broadcast in the acquired SIB corresponding to the target cell and the UE-specific information received in the HO command message (e.g., dedicated RRC message from source cell) to form a legacy HO command and executes the HO according to the generated HO command.

In another embodiment, a network determines a time interval or a starting time for which a first cell broadcasts cell-specific system information of a second cell, e.g., SIBy, based on satellite location and/or ephemeris information, and the first cell transmits the system information of the second cell based on the determination. The first and second cells may have overlapped coverage, e.g., the second cell overlays with the first cell. Further, the first cell may provide a UE with timing, location, and/or ephemeris information regarding when the first cell broadcasts the system information of the second cell. The UE can acquire the system information of the second cell based on the timing, location, and/or ephemeris information.

In an example, SIBy contains cell-specific parameters of a neighbor cell.

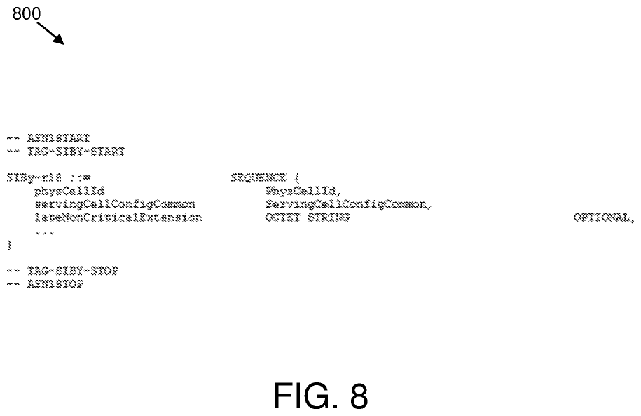

FIG. 8 is a diagram illustrating one embodiment of a SIBy IE 800.

In yet another embodiment, a UE receives a conditional reconfiguration including one or more sets of reconfiguration parameters for one or more candidate target special cells (“SpCells”) for conditional HO. The UE considers that a set of reconfiguration parameters corresponding to a candidate target SpCell in the conditional reconfiguration are valid and activated upon acquiring a SIB type associated with the candidate target SpCell. The set of reconfiguration parameters include a configured RACH resource and a configured new RNTI and exclude cell-specific configuration parameter spCellConfigCommon.

In an implementation, a UE can trigger conditional HO with a candidate target cell based on a configured RACH resource and a configured new RNTI, once the UE receives broadcast system information of the candidate target cell from a source cell (e.g., a current serving cell). The UE may evaluate measurement results to trigger the conditional HO in addition to acquiring the system information of the candidate target cell. That is, after the UE evaluates a condition of each configured candidate target SpCell and acquires necessary system information of a target SpCell, the UE applies the conditional reconfiguration associated with the target SpCell which fulfils associated execution condition.

Specifically, FIG. 9 is a schematic block diagram illustrating one embodiment of a system 900 for a broadcast based HO procedure. The system 900 includes a UE 902, a source gNB 904, and a target gNB 906. Each of the communications in system 900 may include one or more messages.

In a first communication 908, the source gNB 904 transmits SIBx for NTN-based neighboring cell measurement configuration. The UE 902 performs 910 SIBy request triggering based on an NTN cell measurement. In a second communication 912, the UE 902 requests SIBy for a target NTN cell. In a third communication 914, the source gNB 904 transmits SIBy including SI of the target NTN cell. Further, in a fourth communication 916, HO preparation is communicated. Moreover, in a fifth communication 918, the source gNB 904 transmits UE-specific HO parameters. In a sixth communication 920, communications are made to switch to the target NTN cell. Further, in a seventh communication 922, the UE 902 transmits an RRC reconfiguration complete message.

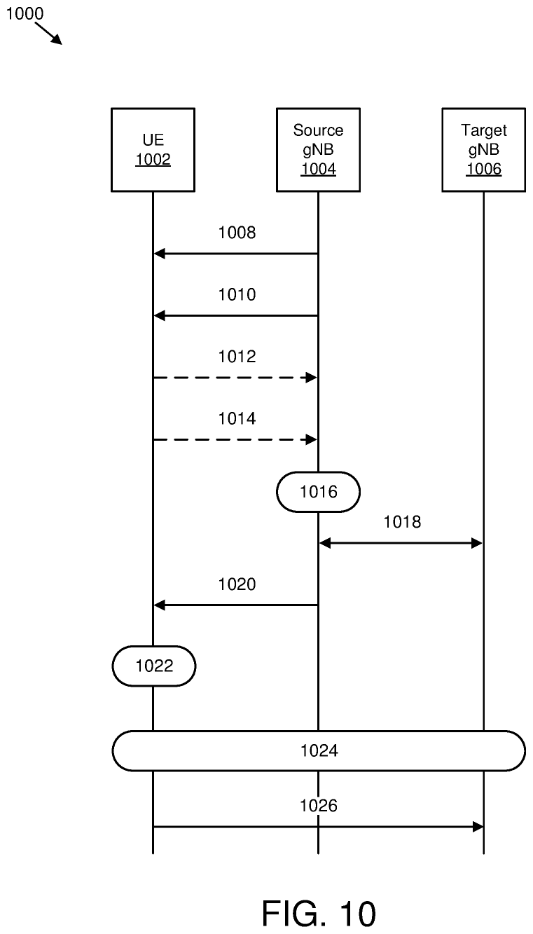

In an example shown in FIG. 10, a source gNB configures a UE with UE-specific conditional HO parameters and determines conditional HO activation triggering based on a measurement report or on-demand request for SIBy (e.g., SIB including cell-specific parameters of a target cell) that is received from the UE or other UEs. With SIBy transmission by the source gNB, the source gNB and the target gNB expect HO execution by the UE based on the UE-specific conditional HO parameters.

In other embodiments, a set of cells provide a SIBy in a single frequency network manner (e.g., SIBy is transmitted by the set of cells on a common time and frequency resource), where the SIBy includes cell-specific parameters of an overlaying cell that has coverage including coverages of the set of cells. The set of cells transmitting the SIBy in the SFN manner coordinates to determine the common time and frequency resource for the SIBy delivery.

In one embodiment, a source cell transmits a first number of SSBs in an SSB burst set and performs beam sweeping of a system information message with a second number of PDSCHs, where each PDSCH is quasi-co-located with one SSB of the SSB burst set and includes the system information message including a SIB that carries cell-specific parameters of a target cell and where the second number is smaller than the first number. The source cell provides an indication of a set of transmitted SSBs in the SSB burst set and further provides an indication of a subset of SSBs selected from the set of transmitted SSBs in the SSB burst set, where each of the second number of PDSCHs carrying the system information messages is quasi-co-located with each SSB of the subset of SSBs.

In an example shown in FIG. 5, if some UEs served by an NTN cell (e.g., a source cell with a wider coverage) may be handed over to a TN cell (e.g., a target cell with a smaller coverage) to support low-latency applications, the NTN cell may broadcast a SIB carrying cell-specific parameters of the TN cell with a subset of beams selected from a set of SSB transmission beams of the NTN cell.

FIG. 10 is a schematic block diagram illustrating one embodiment of a system 1000 for a conditional HO procedure. The system 1000 includes a UE 1002, a source gNB 1004, and a target gNB 1006. Each of the communications in system 1000 may include one or more messages.

In a first communication 1008, the source gNB 1004 transmits SIBx for NTN-based neighboring cell measurement configuration. In a second communication 1010, the source gNB 1004 transmits UE-specific CHO parameters. Further, in an optional third communication 1012, the UE 1002 transmits a measurement report to the source gNB 1004. Moreover, in an optional fourth communication 1014, the UE 1002 transmits a request for SIBy for a target NTN cell. The source gNB 1004 determines 1016 CHO activation triggering. Further, in a fifth communication 1018, HO preparation is communicated. In a sixth communication 1020, the source gNB 1004 transmits SIBy including SI of the target NTN cell. The UE 1002 determines 1022 to perform HO to the target NTN cell. In a seventh communication 1024, communications are made to switch to the target NTN cell. Further, in an eighth communication 1026, the UE 1002 transmits an RRC reconfiguration complete message.

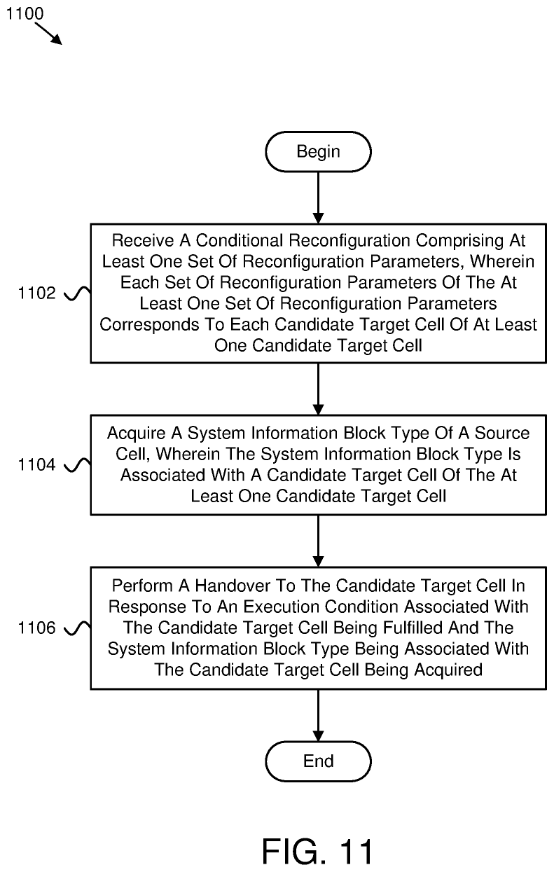

FIG. 11 is a flow chart diagram illustrating one embodiment of a method 1100 for a conditional reconfiguration corresponding to HO to a target cell. In some embodiments, the method 1100 is performed by an apparatus, such as the remote unit 102. In certain embodiments, the method 1100 may be performed by a processor executing program code, for example, a microcontroller, a microprocessor, a CPU, a GPU, an auxiliary processing unit, a FPGA, or the like.

In various embodiments, the method 1100 includes receiving 1102, at a UE, a conditional reconfiguration including at least one set of reconfiguration parameters. Each set of reconfiguration parameters of the at least one set of reconfiguration parameters corresponds to each candidate target cell of at least one candidate target cell. In some embodiments, the method 1100 includes acquiring 1104 a SIB type of a source cell. The SIB type is associated with a candidate target cell of the at least one candidate target cell. In certain embodiments, the method 1100 includes performing 1106 a HO to the candidate target cell in response to an execution condition associated with the candidate target cell being fulfilled and the SIB type being associated with the candidate target cell being acquired.

In certain embodiments, performing the HO comprises applying a set of reconfiguration parameters of the at least one set of reconfiguration parameters corresponding to the candidate target cell. In some embodiments: the SIB type associated with the candidate target cell comprises cell-specific parameters of the candidate target cell; and performing the HO further comprises applying the cell-specific parameters of the candidate target cell. In various embodiments, the set of reconfiguration parameters comprises a random access channel resource and a UE identity associated with the candidate target cell.

In one embodiment, the method 1100 further comprises receiving timing information, wherein based on the timing information the SIB type associated with the candidate target cell is transmitted from the source cell, and the SIB type is acquired based on the timing information. In certain embodiments, the method 1100 further comprises receiving location information and initiating acquisition of the SIB type based on the location information. In some embodiments, the method 1100 further comprises sending an on-demand system information request for the SIB type, wherein the SIB type associated with the candidate target cell is acquired in response to sending the on-demand system information request for the SIB type.

In various embodiments, the method 1100 further comprises: receiving a measurement and reporting configuration comprising at least one system information request triggering condition; and performing a measurement according to the measurement and reporting configuration; wherein the on-demand system information request for the SIB type is sent in response to a corresponding system information request triggering condition of the at least one system information request triggering condition being met based on the measurement. In one embodiment, the method 1100 further comprises: receiving a cell-specific measurement and reporting configuration in a system information message, wherein the cell-specific measurement and reporting configuration is applicable in response to the UE being in a RRC connected state; and performing a measurement according to the cell-specific measurement and reporting configuration.

In certain embodiments, the cell-specific measurement and reporting configuration comprises an indication of a set of NTN network cells. In some embodiments, the method 1100 further comprises: receiving a first indication of a set of SSB in an SSB burst set, wherein the set of SSBs is transmitted by a network entity; and receiving a second indication of a subset of SSBs selected from the set of SSBs; wherein acquiring the SIB type associated with the candidate target cell comprises receiving a PDSCH carrying the SIB type associated with the candidate target cell, and the PDSCH is quasi-co-located with one SSB of the subset of SSBs.

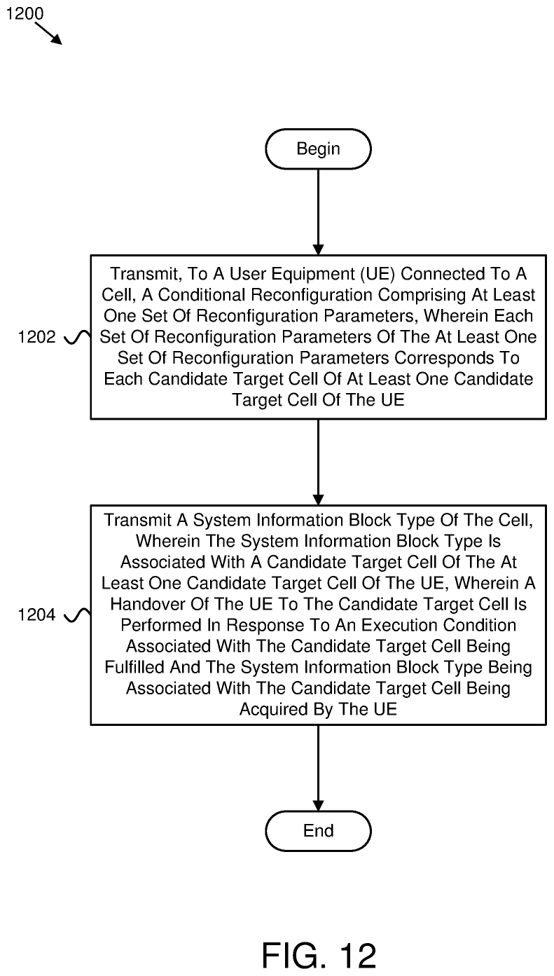

FIG. 12 is a flow chart diagram illustrating another embodiment of a method 1200 for a conditional reconfiguration corresponding to HO to a target cell. In some embodiments, the method 1200 is performed by an apparatus, such as the network unit 104. In certain embodiments, the method 1200 may be performed by a processor executing program code, for example, a microcontroller, a microprocessor, a CPU, a GPU, an auxiliary processing unit, a FPGA, or the like.

In various embodiments, the method 1200 includes transmitting 1202, from a network device to a UE connected to a cell, a conditional reconfiguration including at least one set of reconfiguration parameters. Each set of reconfiguration parameters of the at least one set of reconfiguration parameters corresponds to each candidate target cell of at least one candidate target cell of the UE. In some embodiments, the method 1200 includes transmitting 1204 a SIB type of the cell. The SIB type is associated with a candidate target cell of the at least one candidate target cell of the UE. A HO of the UE to the candidate target cell is performed in response to an execution condition associated with the candidate target cell being fulfilled and the SIB type being associated with the candidate target cell being acquired by the UE.

In certain embodiments, the SIB type associated with the candidate target cell comprises cell-specific parameters of the candidate target cell. In some embodiments, the method 1200 further comprises transmitting timing information, wherein the SIB type is transmitted based on the timing information. In various embodiments, the method 1200 further comprises transmitting location information, wherein the UE acquires the SIB type based on the location information.

In one embodiment, the method 1200 further comprises receiving an on-demand system information request for the SIB type, wherein the SIB type associated with the candidate target cell is transmitted in response to receiving the on-demand system information request for the SIB type. In certain embodiments, the method 1200 further comprises transmitting a measurement and reporting configuration comprising at least one system information request triggering condition. In some embodiments, the method 1200 further comprises: transmitting a first indication of a set of SSB in an SSB burst set, wherein the set of SSBs is transmitted in the cell; and transmitting a second indication of a subset of SSBs selected from the set of SSBs.

In one embodiment, an apparatus comprises a UE. The apparatus further comprises: a receiver that receives a conditional reconfiguration comprising at least one set of reconfiguration parameters, wherein each set of reconfiguration parameters of the at least one set of reconfiguration parameters corresponds to each candidate target cell of at least one candidate target cell; and a processor that: acquires a SIB type of a source cell, wherein the SIB type is associated with a candidate target cell of the at least one candidate target cell; and performs a HO to the candidate target cell in response to an execution condition associated with the candidate target cell being fulfilled and the SIB type being associated with the candidate target cell being acquired.

In certain embodiments, the processor performing the HO comprises the processor applying a set of reconfiguration parameters of the at least one set of reconfiguration parameters corresponding to the candidate target cell.

In some embodiments: the SIB type associated with the candidate target cell comprises cell-specific parameters of the candidate target cell; and the processor performing the HO further comprises the processor applying the cell-specific parameters of the candidate target cell.

In various embodiments, the set of reconfiguration parameters comprises a random access channel resource and a UE identity associated with the candidate target cell.

In one embodiment, the receiver receives timing information, wherein based on the timing information the SIB type associated with the candidate target cell is transmitted from the source cell, and the SIB type is acquired based on the timing information.

In certain embodiments, the receiver receives location information and initiating acquisition of the SIB type based on the location information.

In some embodiments, the apparatus further comprising a transmitter, wherein the transmitter sends an on-demand system information request for the SIB type, and the SIB type associated with the candidate target cell is acquired in response to sending the on-demand system information request for the SIB type.

In various embodiments: the receiver receives a measurement and the transmitter reports configuration comprising at least one system information request triggering condition; the processor performs a measurement according to the measurement and reporting configuration; and the on-demand system information request for the SIB type is sent in response to a corresponding system information request triggering condition of the at least one system information request triggering condition being met based on the measurement.

In one embodiment: the receiver receives a cell-specific measurement and reporting configuration in a system information message, wherein the cell-specific measurement and reporting configuration is applicable in response to the UE being in a RRC connected state; and the processor performs a measurement according to the cell-specific measurement and reporting configuration.

In certain embodiments, the cell-specific measurement and reporting configuration comprises an indication of a set of NTN network cells.

In some embodiments: the receiver receives a first indication of a set of SSB in an SSB burst set, wherein the set of SSBs is transmitted by a network entity; the receiver receives a second indication of a subset of SSBs selected from the set of SSBs; and the processor acquiring the SIB type associated with the candidate target cell comprises the receiver receiving a PDSCH carrying the SIB type associated with the candidate target cell, and the PDSCH is quasi-co-located with one SSB of the subset of SSBs.

In one embodiment, a method of a UE comprises: receiving a conditional reconfiguration comprising at least one set of reconfiguration parameters, wherein each set of reconfiguration parameters of the at least one set of reconfiguration parameters corresponds to each candidate target cell of at least one candidate target cell; acquiring a SIB type of a source cell, wherein the SIB type is associated with a candidate target cell of the at least one candidate target cell; and performing a HO to the candidate target cell in response to an execution condition associated with the candidate target cell being fulfilled and the SIB type being associated with the candidate target cell being acquired.

In certain embodiments, performing the HO comprises applying a set of reconfiguration parameters of the at least one set of reconfiguration parameters corresponding to the candidate target cell.

In some embodiments: the SIB type associated with the candidate target cell comprises cell-specific parameters of the candidate target cell; and performing the HO further comprises applying the cell-specific parameters of the candidate target cell.

In various embodiments, the set of reconfiguration parameters comprises a random access channel resource and a UE identity associated with the candidate target cell.

In one embodiment, the method further comprises receiving timing information, wherein based on the timing information the SIB type associated with the candidate target cell is transmitted from the source cell, and the SIB type is acquired based on the timing information.

In certain embodiments, the method further comprises receiving location information and initiating acquisition of the SIB type based on the location information.

In some embodiments, the method further comprises sending an on-demand system information request for the SIB type, wherein the SIB type associated with the candidate target cell is acquired in response to sending the on-demand system information request for the SIB type.

In various embodiments, the method further comprises: receiving a measurement and reporting configuration comprising at least one system information request triggering condition; and performing a measurement according to the measurement and reporting configuration; wherein the on-demand system information request for the SIB type is sent in response to a corresponding system information request triggering condition of the at least one system information request triggering condition being met based on the measurement.

In one embodiment, the method further comprises: receiving a cell-specific measurement and reporting configuration in a system information message, wherein the cell-specific measurement and reporting configuration is applicable in response to the UE being in a RRC connected state; and performing a measurement according to the cell-specific measurement and reporting configuration.

In certain embodiments, the cell-specific measurement and reporting configuration comprises an indication of a set of NTN network cells.

In some embodiments, the method further comprises: receiving a first indication of a set of SSB in an SSB burst set, wherein the set of SSBs is transmitted by a network entity; and receiving a second indication of a subset of SSBs selected from the set of SSBs; wherein acquiring the SIB type associated with the candidate target cell comprises receiving a PDSCH carrying the SIB type associated with the candidate target cell, and the PDSCH is quasi-co-located with one SSB of the subset of SSBs.

In one embodiment, an apparatus comprises a network device. The apparatus further comprises: a transmitter that: transmits, to a UE connected to a cell, a conditional reconfiguration comprising at least one set of reconfiguration parameters, wherein each set of reconfiguration parameters of the at least one set of reconfiguration parameters corresponds to each candidate target cell of at least one candidate target cell of the UE; and transmits a SIB type of the cell, wherein the SIB type is associated with a candidate target cell of the at least one candidate target cell of the UE, wherein a HO of the UE to the candidate target cell is performed in response to an execution condition associated with the candidate target cell being fulfilled and the SIB type being associated with the candidate target cell being acquired by the UE.

In certain embodiments, the SIB type associated with the candidate target cell comprises cell-specific parameters of the candidate target cell.

In some embodiments, the transmitter transmits timing information, wherein the SIB type is transmitted based on the timing information.

In various embodiments, the transmitter transmits location information, wherein the UE acquires the SIB type based on the location information.

In one embodiment, the apparatus further comprises a receiver that receives an on-demand system information request for the SIB type, wherein the SIB type associated with the candidate target cell is transmitted in response to receiving the on-demand system information request for the SIB type.

In certain embodiments, the transmitter transmits a measurement and reporting configuration comprising at least one system information request triggering condition.

In some embodiments, the transmitter transmits: a first indication of a set of SSB in an SSB burst set, wherein the set of SSBs is transmitted in the cell; and a second indication of a subset of SSBs selected from the set of SSBs.

In one embodiment, a method of a network device comprises: transmitting, to a UE connected to a cell, a conditional reconfiguration comprising at least one set of reconfiguration parameters, wherein each set of reconfiguration parameters of the at least one set of reconfiguration parameters corresponds to each candidate target cell of at least one candidate target cell of the UE; and transmitting a SIB type of the cell, wherein the SIB type is associated with a candidate target cell of the at least one candidate target cell of the UE, wherein a HO of the UE to the candidate target cell is performed in response to an execution condition associated with the candidate target cell being fulfilled and the SIB type being associated with the candidate target cell being acquired by the UE.

In certain embodiments, the SIB type associated with the candidate target cell comprises cell-specific parameters of the candidate target cell.

In some embodiments, the method further comprises transmitting timing information, wherein the SIB type is transmitted based on the timing information.

In various embodiments, the method further comprises transmitting location information, wherein the UE acquires the SIB type based on the location information.

In one embodiment, the method further comprises receiving an on-demand system information request for the SIB type, wherein the SIB type associated with the candidate target cell is transmitted in response to receiving the on-demand system information request for the SIB type.

In certain embodiments, the method further comprises transmitting a measurement and reporting configuration comprising at least one system information request triggering condition.

In some embodiments, the method further comprises: transmitting a first indication of a set of SSB in an SSB burst set, wherein the set of SSBs is transmitted in the cell; and transmitting a second indication of a subset of SSBs selected from the set of SSBs.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a conditional reconfiguration comprising at least one set of reconfiguration parameters, wherein each set of reconfiguration parameters of the at least one set of reconfiguration parameters corresponds to each candidate target cell of at least one candidate target cell;
acquire a system information block (SIB) type of a source cell, wherein the SIB type carries information of a candidate target cell of the at least one candidate target cell; and
perform a handover (HO) to the candidate target cell in response to an execution condition associated with the candidate target cell being fulfilled and the SIB type carries information of the candidate target cell being acquired.

2. The UE of claim 1, wherein at least one processor is configured to cause the UE to apply a set of reconfiguration parameters of the at least one set of reconfiguration parameters corresponding to the candidate target cell.

3. The UE of claim 2, wherein:
the SIB type carries information of the candidate target cell comprises cell-specific parameters of the candidate target cell; and
the at least one processor is configured to cause the UE to apply the cell-specific parameters of the candidate target cell.

4. The UE of claim 2, wherein the set of reconfiguration parameters comprises a random access channel (RACH) resource and a UE identity associated with the candidate target cell.

5. The UE of claim 1, wherein the at least one processor is configured to cause the UE to receive timing information, based on the timing information the SIB type carries information of the candidate target cell is transmitted from the source cell, and the SIB type is acquired based on the timing information.

6. The UE of claim 1, wherein the at least one processor is configured to cause the UE to receive location information and initiate acquisition of the SIB type based on the location information.

7. The UE of claim 1, wherein the at least one processor is configured to cause the UE to send an on-demand system information (SI) request for the SIB type, and the SIB type carries information of the candidate target cell is acquired in response to sending the on-demand SI request for the SIB type.

8. The UE of claim 7, wherein:
the at least one processor is configured to cause the UE to receive a measurement and report configuration comprising at least one SI request triggering condition;
the at least one processor is configured to cause the UE to perform a measurement according to the measurement and reporting configuration; and
the on-demand SI request for the SIB type is sent in response to a corresponding SI request triggering condition of the at least one SI request triggering condition being met based on the measurement.

9. The UE of claim 1, wherein the at least one processor is configured to cause the UE to:
receive a cell-specific measurement and reporting configuration in a system information (SI) message, wherein the cell-specific measurement and reporting configuration is applicable in response to a user equipment (UE) being in a radio resource control (RRC) connected state; and
perform a measurement according to the cell-specific measurement and reporting configuration.

10. The UE of claim 9, wherein the cell-specific measurement and reporting configuration comprises an indication of a set of non-terrestrial (NTN) network cells.

11. The UE of claim 1, wherein the at least one processor is configured to cause the UE to:
receive a first indication of a set of synchronization signal and physical broadcast channel block (SSB) in an SSB burst set, wherein the set of SSBs is transmitted by a network entity;
receive a second indication of a subset of SSBs selected from the set of SSBs; and
receive a physical downlink shared channel (PDSCH) carrying the SIB type carries information of the candidate target cell, and the PDSCH is quasi-co-located with one SSB of the subset of SSBs.

12. A method performed by a user equipment (UE), the method comprising:
receiving a conditional reconfiguration comprising at least one set of reconfiguration parameters, wherein each set of reconfiguration parameters of the at least one set of reconfiguration parameters corresponds to each candidate target cell of at least one candidate target cell;
acquiring a system information block (SIB) type of a source cell, wherein the SIB type carries information of a candidate target cell of the at least one candidate target cell; and
performing a handover (HO) to the candidate target cell in response to an execution condition associated with the candidate target cell being fulfilled and the SIB type carries information of the candidate target cell being acquired.

13. The method of claim 12, further comprising receiving location information and initiating acquisition of the SIB type based on the location information.

14. A base station, comprising:
at least one memory; and
at least one processor coupled with the at least one memory and configured to cause the base station to:
transmit, to a user equipment (UE) connected to a cell, a conditional reconfiguration comprising at least one set of reconfiguration parameters, wherein each set of reconfiguration parameters of the at least one set of reconfiguration parameters corresponds to each candidate target cell of at least one candidate target cell of the UE; and
transmit a system information block (SIB) type of the cell, wherein the SIB type carries information of a candidate target cell of the at least one candidate target cell of the UE, wherein a handover (HO) of the UE to the candidate target cell is performed in response to an execution condition associated with the candidate target cell being fulfilled and the SIB type carries information of the candidate target cell being acquired by the UE.

15. The base station of claim 14, wherein the at least one processor is configured to cause the base station to transmit location information, and the UE acquires the SIB type based on the location information.

16. A processor for wireless communication, comprising:
at least one controller coupled with at least one memory and configured to cause the processor to:
receive a conditional reconfiguration comprising at least one set of reconfiguration parameters, wherein each set of reconfiguration parameters of the at least one set of reconfiguration parameters corresponds to each candidate target cell of at least one candidate target cell;
acquire a system information block (SIB) type of a source cell, wherein the SIB type carries information of a candidate target cell of the at least one candidate target cell; and
perform a handover (HO) to the candidate target cell in response to an execution condition associated with the candidate target cell being fulfilled and the SIB type carries information of the candidate target cell being acquired.

17. The processor of claim 16, wherein the at least one controller is configured to cause the processor to apply a set of reconfiguration parameters of the at least one set of reconfiguration parameters corresponding to the candidate target cell.

18. The processor of claim 17, wherein:
the SIB type carries information of the candidate target cell comprises cell-specific parameters of the candidate target cell; and
the at least one controller is configured to cause the processor to apply the cell-specific parameters of the candidate target cell.

19. The processor of claim 17, wherein the set of reconfiguration parameters comprises a random access channel (RACH) resource and a UE identity associated with the candidate target cell.

20. The processor of claim 16, wherein the at least one controller is configured to cause the processor to receive timing information, based on the timing information the SIB type carries information of the candidate target cell is transmitted from the source cell, and the SIB type is acquired based on the timing information.
